(19) United States
(12) Patent Application Publication
(10) Pub. No.: US 2008/0220173 A1
(43) Pub. Date: Sep. 11, 2008

(54) Coating Agents Containing Adducts Having an Alkoxysilane Functionality

(75) Inventors: Andreas Poppe, Sendenhorst (DE); Elke Westhoff, Steinfurt (DE); Wilfried Stuebbe, Greven (DE); Manuela Niemeier, Drensteinfurt (DE); Dunja Mikolajetz, Ascheberg (DE); Simone Hesener, Muenster (DE); Andre Brosseit, Hamm (DE); Karin Wermelt, Muenster (DE); Guenter Klein, Muenster (DE); Martina Moellers, Drensteinfurt (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AKTIENGESELLSCHAFT, Muenster (DE)

(21) Appl. No.: 11/575,766

(22) PCT Filed: Sep. 3, 2005
(86) PCT No.: PCT/EP05/09495

§ 371 Date: Mar. 22, 2007

(30) Foreign Application Priority Data
Oct. 19, 2004 (DE) 10 2004 050 747.3

(51) Int. Cl. C09D 175/04; C08G 18/80; B05D 1/36

(52) U.S. Cl. 427/407.1; 106/287.13

(57) ABSTRACT

The invention relates to a coating material comprising (A) at least 50% by weight, based on the amount of nonvolatile substances in the coating material, of at least one compound (A1) containing at least one reactive group of the formula(I)

—NR—C(O)—N—(X—SiR″ₓ(OR′)₃₋ₓ₎ₙ(X′—SiR″_{y}(OR′)_{3-y)m} (I)
where
R=hydrogen, alkyl, cycloalkyl, aryl or aralkyl, the carbon chain being uninterrupted or interrupted by nonadjacent oxygen, sulfur or NRa groups, with Ra=alkyl, cycloalkyl, aryl or aralkyl,
R′=hydrogen, alkyl or cycloalkyl, the carbon chain being uninterrupted or interrupted by nonadjacent oxygen, sulfur or NRa groups,
X, X′=linear and/or branched alkylene or cycloalkylene radical of 2 to 20 carbon atoms,
R″=alkyl, cycloalkyl, aryl or aralkyl, the carbon chain being uninterrupted or interrupted by nonadjacent oxygen, sulfur or NRa groups,
n=0 to 2,
m=0 to 2,
m+n=2, and
x, y=0 to 2,
(B) a catalyst for the crosslinking of the —Si(OR′)_{3-X(y)} units, and
(C) an aprotic solvent or a mixture of aprotic solvents.

The present invention relates to thermally curable, high scratch resistance coating materials based on aprotic solvents and comprising adducts with alkoxysilane functionality, the adducts containing at least one urea group.

Solvent-containing coating materials comprising binders based on poly(meth)acrylates which contain lateral and/or terminal alkoxysilane groups are known for example from patents and patent applications U.S. Pat. No. 4,043,953, U.S. Pat. No. 4,499,150, U.S. Pat. No. 4,499,151, EP-A-0 549 643 and WO-A-92/20643. The coating materials described there are cured with catalysis by Lewis acids and optionally in the presence of small amounts of water, with the formation of Si—O—Si networks. The coating materials are used inter alia as clearcoat materials in OEM systems. Although such clearcoats already exhibit high scratch resistance and a comparatively good weathering stability, they have deficiencies which make it difficult to use them as heavy-duty OEM clearcoat materials.

Thus because of the relatively broad molecular weight distribution of the poly(meth)acrylates containing alkoxysilane groups in general in the clearcoat materials it is possible to realize solids contents of less than 50% by weight. Where fractions are higher, the coating materials are difficult to process, owing to their high viscosity. On curing, moreover, transesterification of the —Si(O-alkyl)₃ groups with ester units of the adjacent alkyl (meth)acrylate comonomer units may result in the formation of unwanted Si—O—C nodes, in competition to the desired Si—O—Si nodes, the Si—O—C nodes being unstable to hydrolysis and leading to reduced chemical resistance in the resultant coating. Since the heavy-duty OEM clearcoat materials are intended to have a very high weathering stability, it is a concern that the poly(meth)acrylate networks have reduced weathering stability as compared with polyurethane networks.

EP-A-0 267 698 describes solventborne coating materials whose binder constituents include (1) crosslinkable adducts containing alkoxysilane groups, obtainable by successively reacting polyisocyanates with hydroxyalkyl (meth)acrylates (Michael reaction) and then with aminoalkylalkoxysilanes, and (2) poly(meth)acrylates which contain lateral and/or terminal alkoxysilane groups. The readily accessible amine groups in the adducts, formed in the course of the Michael reaction, lead to a reduction in the water resistance of the cured coatings. Moreover, in the curing operation, these amine groups can react with the —Si(OR)₃ groups to form Si—N—C nodes, which are unstable to hydrolysis and lead to reduced chemicals resistance of the resultant coating. As far as the deleterious effect of the alkoxysilane-functionalized poly(meth)acrylates in the coating materials are concerned, the above comments apply.

U.S. Pat. No. 4,598,131 describes solventborne coating materials comprising crosslinkable adducts containing alkoxysilane groups, obtainable by successively reacting tetraalkyl orthosilicate with amino alcohols and then with polyisocyanates. As a result of their synthesis such adducts contain unwanted Si—O—C and/or Si—N—C nodes, which are unstable to hydrolysis and lead to a reduced chemicals resistance of the resultant coating.

EP-A-0 571 073 describes solventborne coating materials which include as binder constituents (1) crosslinkable adducts of polyisocyanates containing more than one tertiary isocyanate group and aminoalkylalkoxysilanes and (2) poly(meth)acrylates which contain lateral and/or terminal alkoxysilane groups. The tertiary isocyanate groups may adversely effect the elasticity of the network which is obtained after the coating material has been cured, and hence may lead to an impaired gloss after scratch exposure. Moreover, polyisocyanates of this kind are complicated to prepare and of only limited availability. As far as the deleterious effect of the alkoxysilane-functionalized poly(meth)acrylates in the coating material are concerned, the above comments apply.

DE-A-102 37 270 embraces coating materials comprising crosslinkable adducts of isocyanatomethylalkoxysilanes and polyols. The isocyanatomethylalkoxysilanes used in the synthesis are highly toxic and therefore cannot be used without reservation in standard production processes. In particular in the context of their application as automotive clearcoat material, these coating materials also have deficiencies in their surface properties, particularly after loads, such as washing operations, for example.

### PROBLEM AND SOLUTION

The problem addressed by the present invention was to provide coating materials, in particular for OEM clearcoat materials, which do not have the disadvantages of alkoxysilane-functionalized poly-(meth)acrylates, particularly the problematic processing at high solids contents and the unwanted formation of Si—O—C nodes which are unstable to hydrolysis and lead to reduced chemical resistance in the resultant coating. A further problem addressed by the invention was to provide coating materials which lead to a highly weathering-stable network which to a large extent possesses polyurethane and/or polyurea units, with very substantial suppression of the unwanted formation of Si—O—C and Si—N—C nodes. The coatings ought in particular to have a high level of scratch resistance and ought in particular to exhibit a high level of gloss retention after scratching load. In particular the coatings and coating systems, especially the clearcoats, ought to be producible even in coat thicknesses >40 μm without the incidence of stress cracks. This is an essential prerequisite for the use of the coatings and coating systems, particularly the clearcoats, in the particularly technologically and esthetically demanding field of automotive OEM finishing. In this case they must in particular exhibit a particularly high carwash resistance, which is manifested in the practice-oriented AMTEC carwash test by a residual gloss (20° C.) after cleaning in accordance with DIN 67530 of >70% of the original gloss.

Moreover, the new coating materials ought to be preparable easily and with very high reproducibility, and ought not to cause any environmental problems during coating-material application.

The invention accordingly provides coating materials comprising
(A) at least 50% by weight, based on the amount of nonvolatile substances in the coating material, of a compound (A1) containing at least one reactive group of the formula I

—NR—C(O)—N—(X—SiR″ₓ(OR′)₃₋ₓ₎ₙ(X′—SiR″_{y}(OR′)_{3-y)m} (I)
where
R=hydrogen, alkyl, cycloalkyl, aryl or aralkyl, the carbon chain being uninterrupted or interrupted by nonadjacent oxygen, sulfur or NRa groups, with Ra=alkyl, cycloalkyl, aryl or aralkyl,
R′=hydrogen, alkyl or cycloalkyl, the carbon chain being uninterrupted or interrupted by nonadjacent oxygen, sulfur or NRa groups,
X, X′=linear and/or branched alkylene or cycloalkylene radical of 2 to 20 carbon atoms,
R″=alkyl, cycloalkyl, aryl or aralkyl, the carbon chain being uninterrupted or interrupted by nonadjacent oxygen, sulfur or NRa groups,
n=0 to 2,
m=0 to 2,
m+n=2, and
x, y=0 to 2,
(B) a catalyst for the crosslinking of the —Si(OR′)_{3-x(y)} units, and
(C) an aprotic solvent or a mixture of aprotic solvents.

In the light of the prior art it was surprising and unforeseeable for the skilled worker that the problems on whose addressing the present invention is based would be solved by means of the coating material of the invention.

Component (A) of the invention can be prepared with particular simplicity and very high reproducibility and causes no significant toxicological or environmental problems in the course of coating-material application.

The coating materials of the invention were able to be prepared with simplicity and very high reproducibility and when used in the liquid state were adjustable to solids contents >40% by weight, preferably >45% by weight, in particular >50% by weight, without detriment to their very good transport properties, storage stability and processing properties, particularly their application properties.

The coating materials of the invention provided new coatings and coating systems, especially clearcoats, which were of high scratch resistance. The chemicals resistance of the coatings is excellent. Additionally the coatings and coating systems of the invention, especially the clearcoats, could be produced even in coat thicknesses >40 μm without incidence of stress cracks. Accordingly the coatings and coat systems of the invention, especially the clearcoats, could be used in the particularly technologically and esthetically demanding field of automotive OEM finishing. In that context they were notable in particular for a particularly high carwash resistance and scratch resistance, which could be underlined on the basis of the practically oriented AMTEC carwash test by a residual gloss (20°) after cleaning in accordance with DIN 67530 of >70% of the original gloss.

### DESCRIPTION OF THE INVENTION

### Component (A) of the Coating Material

Component (A) of the invention contains at least 50% by weight, based on the amount of nonvolatile substances in the coating material, of a compound (A1) containing at least one reactive group of the formula I

—NR—C(O)—N—(X—SiR″ₓ(OR′)₃₋ₓ₎ₙ(x′—SiR″_{y}(OR′)_{3-y)m} (I)
where
R=hydrogen, alkyl, cycloalkyl, aryl or aralkyl, the carbon chain being uninterrupted or interrupted by nonadjacent oxygen, sulfur or NRa groups, with Ra=alkyl, cycloalkyl, aryl or aralkyl,
R′=hydrogen, alkyl or cycloalkyl, the carbon chain being uninterrupted or interrupted by nonadjacent oxygen, sulfur or NRa groups, R″ preferably being alkyl of 1 to 6 carbon atoms, more preferably methyl and/or ethyl,
X, X′=linear and/or branched alkylene or cycloalkylene radical of 2 to 20 carbon atoms, X, X′ preferably being alkylene of 2 to 6 carbon atoms, more preferably alkylene of 2 to 4 carbon atoms,
R″=alkyl, cycloalkyl, aryl or aralkyl, the carbon chain being uninterrupted or interrupted by nonadjacent oxygen, sulfur or NRa groups, R″ preferably being alkyl of 1 to 6 carbon atoms, more preferably methyl and/or ethyl,
n=0 to 2,
m=0 to 2,
m+n=2, and
x, y=0 to 2, preferably x=0.

Compound (A1) according to the invention is preferably prepared by reacting at least one di- and/or polyisocyanate (PI) with at least one aminosilane of the formula II:

HN—(X—SiR″ₓ(OR′)₃₋ₓ₎ₙ(X′—SiR″_{y}(OR′)_{3-y)m} (II)

the substituents and indices having the meanings given above.

Particularly preferred aminosilanes (III) are bis(2-ethyltrimethoxysilyl)amine, bis(3-propyltrimethoxysilyl)amine, bis(4-butyltrimethoxysilyl)-amine, bis(2-ethyltriethoxysilyl)amine, bis(3-propyltrimethoxysilyl)amine and/or bis(4-butyltriethoxy-silane)amine. Especially preferred is bis(3-propyltrimethoxy-silyl)amine. Aminosilanes of this kind are available for example under the brand name Dynasilan® from Degussa or Silquest® from OSI. Preferred di- and/or polyisocyanates PI for preparing compound (A1) are conventional substituted or unsubstituted aromatic, aliphatic, cycloaliphatic and/or heterocyclic polyisocyanates. Examples of preferred polyisocyanates are: toluene 2,4-diisocyanate, toluene 2,6-diisocyanate, diphenylmethane 4,4′-diisoyanate, diphenylmethane 2,4′-diisocyanate, p-phenylene diisocyanate, biphenyl diisocyanates, 3,3′-dimethyl-4,4′-diphenylene diisocyanate, tetramethylene 1,4-diisocyanate, hexamethylene 1,6-diisocyanate, 2,2,4-trimethylhexane 1,6-diisocyanate, isophorone diisocyanate, ethylene diisocyanate, dodecane 1,12-diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylenedicyclohexyl diisocyanate (e.g., Desmodur® W from Bayer AG), tetramethylxylyl diisocyanates (e.g., TMXDI® from American Cyanamid), and mixtures of the aforementioned polyisocyanates. Further-preferred polyisocyanates are the biuret dimers and the isocyanurate trimers of the aforementioned diisocyanates. Particularly preferred polyisocyanates PI are hexamethylene 1,6-diisocyanate, isophorone diisocyanate and 4,4-methylenedicyclohexyl diisocyanate, their biuret dimers and/or isocyanurate trimers.

In a further embodiment of the invention the polyisocyanates PI are polyisocyanate prepolymers having urethane structural units, which are obtained by reacting polyols with a stoichiometric excess of the aforementioned polyisocyanates. Polyisocyanate prepolymers of this kind are described for example in U.S. Pat. No. 4,598,131.

Especially preferred compounds (A1) are: reaction products of hexamethylene l,6-diisocyanate and isophorone diisocyanate, and/or their isocyanurate trimers with bis(3-propyltrimethoxysilyl)amine. The polyisocyanates are reacted with the aminosilanes preferably in an inert gas atmosphere at temperatures of not more than 100° C., preferably not more than 60° C.

The resulting compound (A1) includes, in accordance with the invention, at least one structural unit of the aforementioned formula (I); in accordance with the preparation method preferred in accordance with the invention preferably at least 90 mol % of the isocyanate groups of the polyisocyanate PI have undergone reaction with the aminosilanes (II), more preferably at least 95 mol %, to form structural units (I).

The fraction of compound (A1) in the coating material of the invention amounts to at least 50% by weight, based on the amount of nonvolatile substances in the coating material, preferably at least 60% by weight, more preferably at least 70% by weight.

### The Component (B) of the Coating Material

As catalysts (B) for crosslinking the —Si(OR′)_{3-x(y)} units it is possible to use conventional compounds. Examples are Lewis acids (electron deficiency compounds), such as, for example, tin naphthenate, tin benzoate, tin octoate, tin butyrate, dibutyltin dilaurate, dibutyltin diacetate, dibutyltin oxide, lead octoate.

Catalysts used are preferably metal complexes with chelate ligands. The compounds which form chelate ligands are organic compounds containing at least two functional group which are able to coordinate to metal atoms or metal ions. These functional groups are normally electron donors, which give up electrons to metal atoms or metal ions as electron acceptors. Suitable organic compounds are in principle all those of the stated type, provided they do not adversely affect, let alone entirely prevent, the crosslinking of the curable compositions of the invention to cured compositions of the invention. Catalysts which can be used include, for example, the aluminum and zirconium chelate complexes as described for example in the American patent U.S. Pat. No. 4,772,672 A, column 8 line 1 to column 9 line 49. Particular preference is given to aluminum, zirconium, titanium and/or boron chelates, such as aluminum ethyl acetoacetate and/or zirconium ethyl acetoacetate. Particular preference extends to aluminum, zirconium, titanium and/or boron alkoxides and/or esters.

Also of particular preference as component (B) are nanoparticles. Such nanoparticles are preferably incorporated into the nodes at least partly during the crosslinking of the —Si(OR′)_{3-x(y)} units. The nanoparticles are preferably selected from the group consisting of metals and metal compounds, preferably metal compounds.

The metals are preferably selected from main groups three and four and transition groups three to six and one and two of the Periodic Table of the Elements and also the lanthanoids, and preferably from the group consisting of boron, aluminum, gallium, silicon, germanium, tin, zinc, titanium, zirconium, hafnium, vanadium, niobium, tantalum, molybdenum, tungsten and cerium. Use is made in particular of aluminum, silicon, titanium and/or zirconium.

The metal compounds are preferably oxides, oxide hydrates, sulfates, hydroxides or phosphates, especially oxides, oxide hydrates and hydroxides. Very particular preference is given to boehmite nanoparticles.

The nanoparticles preferably have a primary particle size <50, more preferably 5 to 50, in particular 5 to 30 nm.

The catalyst component (B) is used preferably in fractions of from 0.01 to 30% by weight, more preferably in fractions of from 0.1 to 20% by weight, based on the nonvolatile constituents of the coating material of the invention.

### The Component (C) and Further Components of the Coating Material

Suitability as component (C) of the invention is possessed by aprotic solvents, which in the coating material are chemically inert toward components (A) and (B) and also do not react with (A) and (B) when the coating material is cured. Examples of such solvents are aliphatic and/or aromatic hydrocarbons, such as toluene, xylene, solvent naphtha, Solvesso 100 or Hydrosol® (from APAL), ketones, such as acetone, methyl ethyl ketone or methyl amyl ketone, esters, such as ethyl acetate, butyl acetate, pentyl acetate or ethyl epoxypropionate, ethers, or mixtures of the aforementioned solvents. The aprotic solvents or solvent mixtures preferably have a water content of not more than 1% by weight, more preferably not more than 0.5% by weight, based on the solvent. In one preferred embodiment of the invention, during the preparation of the coating material, a mixture of components (A) and (C) is prepared first of all and in a further step is mixed with the remaining components of the coating material of the invention.

In a further embodiment of the invention use is made, as component (D), of further binders, which are able to form network nodes with the Si(OR)₃ groups of component (A) and/or with themselves, where appropriate with catalysis by component (B).

As component (D) it is possible for example to use further oligomers or polymers containing Si(OR)₃ groups, such as the poly(meth)acrylates referred to in the aforementioned patents and patent applications U.S. Pat. No. 4,499,150, U.S. Pat. No. 4,499,151 or EP-A-0 571 073. Components (D) of this kind, however, are used only in amounts such that the polyurethane or polyurea nature of the network and thus the high weathering stability of the cured coating is maintained. In general such poly(meth)acrylates containing Si(OR)₃ groups are used in fractions of up to 40% by weight, preferably of up to 30% by weight, more preferably of up to 25% by weight, based on the nonvolatile constituents of the coating material.

As component (D) it is preferred to use amino resins and/or epoxy resins. Suitable amino resins are the customary and known resins, some of whose methylol and/or methoxy methyl groups may have been defunctionalized by means of carbamate or allophanate groups. Crosslinking agents of this kind are described in patents U.S. Pat. No. 4,710,542 and EP-B-0 245 700 and also in the article by B. Singh and coworkers, “Carbamyl-methylated Melamines, Novel Crosslinkers for the Coatings Industry”, in Advanced Organic Coatings Science and Technology Series, 1991, Volume 13, pages 193 to 207.

Particularly preferred components (D) are epoxy resins, which react preferably with themselves with catalysis by component (B), more preferably aliphatic epoxy resins possessing a high weathering stability. Epoxy resins of this kind are described for example in the monograph by B. Ellis, “Chemistry and Technology of Epoxy Resins” (Blackie Academic & Professional, 1993, pages 1 to 35).

In general the components (D) are used in fractions of up to 40% by weight, preferably of up to 30% by weight, more preferably of up to 25% by weight, based on the nonvolatile constituents of the coating material. In selecting components (D) it should be ensured that the curing of the coating materials is not accompanied, or is accompanied only to a very small extent, by the formation of Si—N—C and/or Si—O—C nodes that are unstable to hydrolysis.

The coating material of the invention may further comprise at least one customary and known coatings additive in effective amounts, i.e., in amounts preferably up to 30% by weight, more preferably up to 25% by weight and in particular up to 20% by weight, based in each case on the nonvolatile constituents of the coating material.

Examples of suitable coatings additives are:
in particular, UV absorbers;
in particular, light stabilizers such as HALS compounds, benzotriazoles or oxalanilides;
free-radical scavengers;
slip additives;
polymerization inhibitors;
defoamers;
reactive diluents, such as are general knowledge from the prior art, which preferably do not react with the —Si(OR)₃ groups of component (A) with the formation of —Si—O—C and/or —Si—N—C nodes;
wetting agents such as siloxanes, fluorine compounds, carboxylic hemiesters, phosphoric esters, polyacrylic acids and copolymers thereof or polyurethanes;
adhesion promoters such as tricyclodecanedimethanol;
leveling agents;
film-forming auxiliaries such as cellulose derivatives;
fillers other than component (B), such as nanoparticles based on silica, alumina or zirconium oxide; for further details refer to Römpp Lexikon “Lacke und Druckfarben”, George Thieme Verlag, Stuttgart, 1998, pages 250 to 252;
rheology control additives such as those from patents WO 94/22968, EP-A-0 276 501, EP-A-0 249 201 or WO 97/12945; crosslinked polymeric micro-particles, as disclosed for example in EP-A-0 008 127; inorganic phyllosilicates such as aluminum magnesium silicates, sodium magnesium and sodium magnesium fluorine lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, polyvinylpyrrolidone, styrene-maleic anhydride or ethylene-maleic anhydride copolymers and their derivatives or hydrophobically modified ethoxylated urethanes or polyacrylates;
and/or flame retardants.

In a further embodiment of the invention the coating material of the invention may further comprise additional pigments and/or fillers and be used for producing pigmented topcoats. The pigments and/or fillers employed for this purpose are known to the skilled worker.

Adhering outstandingly even to already cured electrocoats, surfacer coats, basecoats or customary and known clearcoats, the coatings of the invention produced from the coating materials of the invention are suitable not only for use in automotive OEM finishing but also superlatively for automotive refinish or for scratchproofing exposed areas on coated automobile bodies.

The coating materials of the invention can be applied by any of the customary application methods, such as spraying, knife coating, brushing, flow coating, dipping, impregnating, trickling or rolling, for example. The substrate to be coated may itself be stationary, with the application equipment or unit being in motion. Alternatively the substrate to be coated, especially a coil, may be in motion, with the application unit being stationary relative to the substrate or being in appropriate motion.

It is preferred to employ spray application methods, such as compressed-air spraying, airless spraying, high-speed rotation, or electrostatic spray application (ESTA), in conjunction where appropriate with hot spray application such as hot-air spraying, for example.

Curing of the applied coating materials of the invention may take place after a certain rest time. This rest time is used, for example, for the leveling and degassing of the coating films or for the evaporation of volatile constituents such as solvents. The rest time may be assisted and/or shortened by application of elevated temperatures and/or by a reduced air humidity, provided that this does not entail any damage or change to the coating films, such as premature complete crosslinking.

The thermal curing of the coating materials has no particular features as far as its method is concerned, but instead takes place in accordance with the conventional methods such as heating in a forced-air oven or exposure to IR lamps. Thermal curing may also take place in stages. Another preferred curing method is that of curing with near infrared (NIR) radiation. Thermal curing takes place advantageously at a temperature of 50 to 200° C., more preferably 60 to 190° C. and in particular 80 to 180° C., for a time of 1 min to 5 h, more preferably 2 min to 2 h and in particular 3 min to 90 min.

The coating materials of the invention provide new cured coatings, especially coating systems, especially clearcoats, moldings, especially optical moldings, and self-supporting sheets which are of high scratch resistance and in particular possess chemical stability and weathering stability. The coatings and coating systems of the invention, especially the clearcoats, can also be produced in particular in coat thicknesses >40 μm without incidence of stress cracks.

The coating materials of the invention are therefore outstandingly suitable for use as decorative, protective and/or effect-providing coatings and coating systems, possessing high scratch resistance, on bodies of means of transport (especially motor vehicles, such as motorcycles, buses, trucks or automobiles) or parts thereof; on constructions, interior and exterior; on furniture, windows and doors; on plastics moldings, especially CDs and windows; on small industrial parts, on coils, containers, and packaging; on white goods; on sheets; on optical, electrical and mechanical components, and on hollow glassware and articles of everyday use.

The coating materials and coating systems of the invention, especially the clearcoats, are employed particularly in the especially technologically and esthetically demanding field of automotive OEM finishing. With particular preference the coating materials of the invention are employed in multistage coating processes, particularly in processes where a substrate which may or may not be precoated has applied to it first a pigmented basecoat film and then a film comprising the coating material of the invention. Processes of this kind are described for example in U.S. Pat. No. 4,499,150. Particular qualities which are manifested here include a particularly high chemicals resistance and weathering stability and also a very good carwash resistance and scratch resistance, as demonstrated by means of the practically oriented AMTEC carwash test by a residual gloss (20°) after cleaning in accordance with DIN 67530 of >70%, preferably >80% of the original gloss.

### EXAMPLES

### Preparation Example 1

### Preparation of a Suitable Catalyst (Component (B)

In order to ensure sufficient curing of the clearcoat material a suitable catalyst was prepared first of all. For that purpose 13.01 parts by weight of ethyl acetoacetate were added slowly at room temperature to 20.43 parts by weight of aluminum sec-butoxide in a round-bottomed flask, with stirring and cooling during the addition. Thereafter the reaction mixture was stirred further at room temperature for 1 h.

### Preparation Example 2

Preparation of a Silanized Diisocyanate (HDI with Bisalkoxysilylamine) (Component A1))

A three-necked glass flask equipped with a reflux condenser and a thermometer is charged with 30.4 parts of trimerized hexamethylene diisocyanate (HDI) (Basonat HI 100) and 15.2 parts of solvent naphtha. Under nitrogen blanketing and with stirring, 54.4 parts of bis[3-(trimethoxysilyl)propyl]amine (Silquest A 1170) are metered in at a rate such that 50° C. are not exceeded. After the end of the addition the reaction temperature is held at 50° C. Complete blocking is determined by means of the titration described above. The blocked isocyanate obtained in this way is stable on storage at room temperature for more than one month at 40° C. and following the addition of an aluminum catalyst could be applied as a 2K (two-component) clearcoat material.

### Formulation of Scratch-Resistant and Chemicals-Resistant Coating Materials

To formulate highly scratch-resistant and chemicals-resistant coating materials 90% by weight of the diisocyanate adduct (A1) described in Preparation Example 2 was admixed with 10% by weight of the catalyst (B) described in Preparation Example 1. The resulting coating material was applied and baked at 140° C. for 22 minutes. The scratch resistance of the surfaces of the resultant coating 2 was investigated by means of the steel wool test. The chemicals resistance was investigated by means of the BART test.

TABLE 1
Properties of the coating produced with
the coating material of the invention

| | Coating 2 |
|---|---|
| Steel wool scratch test after 10 BAFS [rating] | 1 |
| BART test [rating] | |
| H₂SO₄ 10% strength | 1 |
| H₂SO₄ 36% strength | 1 |
| HCl 10% strength | 1 |
| H₂SO₃ 6% strength | 1 |
| NaOH 5% strength | 1 |
| DI H₂O | 0 |

The steel wool scratch test was carried out using a hammer to DIN 1041 (weight without shaft: 800 g; shaft length: 35 cm). The test panels were stored at room temperature for 24 hours prior to the test.

The flat side of the hammer was wrapped with one ply of steel wool and fastened to the raised sides using Tesakrepp tape. The hammer was placed onto the clearcoats at right angles. The weighted part of the hammer was guided over the surface of the clearcoat in a track, without tipping and without additional physical force.

For each test 10 back-and-forth strokes (BAFS) were performed by hand. After each of these individual tests the steel wool was replaced.

Following application of the load, the areas under test were cleaned with a soft cloth to remove the residues of steel wool. The areas under test were evaluated visually under artificial light and rated as follows:

| Rating | Damage |
|---|---|
| 1 | none |
| 2 | little |
| 3 | slight |
| 4 | slight to moderate |
| 5 | severe |
| 6 | very severe |

Evaluation took place immediately after the end of the test.

The BART (BASF ACID RESISTANCE TEST) was used to determine the resistance in the clearcoat to acids, alkalis and water drops. In this test the clearcoat was exposed to a temperature load in a gradient oven after baking at 40° C. for 30 minutes. Previously the test substances (10% and 36% strength sulfuric acid; 6% sulfurous acid, 10% strength hydrochloric acid; 5% strength sodium hydroxide solution, DI (i.e., fully demineralized or deionized) water—1, 2, 3 or 4 drops) had been applied in a defined manner using a volumetric pipette. After the substances had been allowed to act they were removed under running water and the damage was assessed visually after 24 h in accordance. with a predetermined scale:

| Rating | Appearance |
|---|---|
| 0 | no defect |
| 1 | slight marking |
| 2 | marking/dulling/no softening |
| 3 | marking/dulling/color change/softening |
| 4 | cracks/incipient etching |
| 5 | clearcoat removed |

Each individual mark (spot) was evaluated and the result was reported in the form of a rating for each test substance.

Additionally the AMTEC test in accordance with DIN 67530 was carried out on coating 2, with the following results (gloss at 20°):

| | |
|---|---|
| Initial gloss: | 88 |

Gloss after damage:

| | |
|---|---|
| with cleaning: | 84, i.e., 95.5% of the |
| | original gloss |
| Reflow time (min): | 120 |
| Reflow temperature (° C.): | 80 |

Gloss after reflow:

| | |
|---|---|
| with cleaning: | 83, i.e., 94.3% of the |
| | original gloss |

1. A multistage coating process comprising
applying to a substrate a film of a coating material based on aprotic solvents, the coating material comprising
(A) at least 50% by weight, based on the amount of nonvolatile substances in the coating material, of at least one compound (A1) comprising at least one reactive group of the formula I
—NR—C(O)—N—(X—SiR″ₓ(OR′)₃₋ₓ₎ₙ(X′—SiR″_{y}(OR′)_{3-y)m} (I)
where
R is a hydrogen, alkyl, cycloalkyl, aryl or aralkyl, the carbon chain being uninterrupted or interrupted by nonadjacent oxygen, sulfur or NRa groups, where Ra is an alkyl, cycloalkyl, aryl or aralkyl,
R′ is a hydrogen, alkyl or cycloalkyl, the carbon chain being uninterrupted or interrupted by nonadjacent oxygen, sulfur or NRa groups,
X, X′ are a linear and/or branched alkylene or cycloalkylene radical of 2 to 20 carbon atoms,
R″ is an alkyl, cycloalkyl, aryl or aralkyl, the carbon chain being uninterrupted or interrupted by nonadjacent oxygen, sulfur or NRa groups,
n=0 to 2,
m=0 to 2,
m+n=2, and
x, y=0 to 2,
(B) a catalyst for the crosslinking of the —Si(OR′)_{3-x(y)} units, and
(C) an aprotic solvent or a mixture of aprotic solvents.

2. The multistage coating process of 1, wherein X and/or X′ is an alkylene of 2 to 4 carbon atoms.

3. The multistage coating process of claim 1, wherein component (A1) is prepared by reacting at least one polyisocyanate PI with at least one aminosilane of the formula II:
HN—(X—SiR″ₓ(OR′)₃₋ₓ₎ₙ(X′—SiR″_{y}(OR′)_{3-y)m} (II).

4. The multistage coating process of claim 3, wherein during the reaction of the polyisocyanate PI with the aminosilanes (II) at least 90 mol % of the isocyanate groups of the polyisocyanate PI are converted into structural units (I).

5. The multistage coating process of claim 3, wherein the polyisocyanate PI is selected from the group consisting of hexamethylene 1,6-diisocyanate, isophorone diisocyanate and 4,4′-methylenedicyclohexyl diisocyanate, the biuret dimers of the aforementioned polyisocyanates, the isocyanurate trimers of the aforementioned polyisocyanates and mixtures thereof.

6. The multistage coating process of claim 1, wherein the catalyst (B) is selected from the group consisting of boron chelates, boron alkoxides, boron esters, aluminum chelates, aluminum alkoxides, aluminum esters, titanium chelates, titanium alkoxides, titanium alkoxides, zirconium chelates, zirconium alkoxides, zirconium esters, nanoparticles of compounds of the elements aluminum, silicon, titanium or zirconium, and mixtures thereof.

7. The multistage coating process of claim 1, wherein catalyst (B) is present at from 0.01% to 30% by weight, based on the amount of nonvolatile substances, in the coating material.

8. The multistage coating process of claim 1, wherein the aprotic solvent (C) has a water content of not more than 1% by weight, based on the solvent.

9. The multistage coating process of claim 1, wherein the coating material further comprises a component (D) in an amount up to 40% by weight, based on the amount of nonvolatile substances, wherein component (D) is able to form network nodes with the —Si(OR′)₃ groups of the component (A) and/or with itself.

10. The multistage coating process of claim 9, wherein component (D) is an aliphatic epoxy resin.

11. A coating material comprising
(A) at least 50% by weight, based on the amount of nonvolatile substances in the coating material, of at least one compound (A1) comprising at least one reactive group of the formula I
—NR—C(O)—N—(X—SiR″ₓ(OR′)₃₋ₓ₎ₙ(X′—SiR″_{y}(OR′)_{3-y)m} (I)
where
R is a hydrogen, alkyl, cycloalkyl, aryl or aralkyl, the carbon chain being uninterrupted or interrupted by nonadjacent oxygen, sulfur or NRa groups, where Ra is an alkyl, cycloalkyl, aryl or aralkyl,
R′ is a hydrogen, methyl or ethyl, the carbon chain being uninterrupted or interrupted by nonadjacent oxygen, sulfur or NRa groups,
X, X′ are a linear and/or branched alkylene radical of 2 to 4 carbon atoms,
R″ is a methyl or ethyl, the carbon chain being uninterrupted or interrupted by nonadjacent oxygen, sulfur or NRa groups,
n=0 to 2,
m=0 to 2,
m+n=2,
x=0, and
y=0 to 2,
(B) a catalyst, selected from the group consisting of boron chelates, boron alkoxides, boron esters, aluminum chelates, aluminum alkoxides, aluminum esters, titanium chelates, titanium alkoxides, titanium esters, zirconium chelates, zirconium alkoxides, zirconium esters, and nanoparticles of compounds of the elements aluminum, silicon, titanium or zirconium, for the crosslinking of the —Si(OR′)_{3-x(y)} units, and
(C) an aprotic solvent or a mixture of aprotic solvents.
